(19) United States
(12) Patent Application Publication
(10) Pub. No.: US 2012/0151277 A1
(43) Pub. Date: Jun. 14, 2012

(54) WEB SERVICE INFORMATION PROCESSING METHOD AND WEB SERVICE COMPOSITING METHOD AND APPARTUS USING THE SAME

(75) Inventors: Yu Chul Jung, Daejeon-si (KR); Hyun Joo Bae, Daejeon-si (KR); Byung Sun Lee, Daejeon-si (KR)

(73) Assignee: Electronics and Telecommunications Research Institute, Daejeon (KR)

(21) Appl. No.: 13/324,280

(22) Filed: Dec. 13, 2011

(30) Foreign Application Priority Data
Dec. 14, 2010 (KR) 10-2010-0127301

(51) Int. Cl. G06F 11/00

(52) U.S. Cl. 714/47.3; 714/E11.02

(57) ABSTRACT

Disclosed is a method and apparatus for realizing an effective service adaptation in consideration of delay factors possibly generated in combining (or compositing) already existing Web services in constituting a composite Web service. A failure or delay in executing a Web service is predicted in consideration of features (or factors) of QoS of Web services constituting a composite Web service, and a substitute Web service is executed or a speculative execution is performed to thus stably and quickly constitute a composite Web service.

This application claims the benefit of priority of Korean Patent Application No. 10-2010-0127301 filed on Dec. 14, 2011, which are incorporated by reference in their entirety herein.

### BACKGROUND OF THE INVENTION

1. Field of the Invention

The present invention relates to a method for processing a Web service and, more particularly, to a Web service compositing technique based on an open application programming interface (API).

2. Description of the Related Art

Open application programming interface (API) type Web services are increasing. A Web service composition or mashup for creating a new service by combining existing Web services by using open APIs has been drawing much attention.

The Web service composition takes on various aspects depending on the performance of a user's device, a network situation, or the state of a server providing a Web service. In particular, when heterogeneous Web services are combined (or composited) in a mobile communication environment, it is not easy to predict a possible delay or a service failure (or a service fault) and effectively combine Web services accordingly.

Thus, a method for analyzing the cause of a service delay or a service failure and presenting a solution based on the analysis results is required.

### SUMMARY OF THE INVENTION

Therefore, an object of the present invention is to provide a Web service compositing apparatus positioned and operating in a user terminal in configuring a composite (complex or combined) Web service based on an open application programming interface (API).

Another object of the present invention is to provide a method for using a personalized composite Web service by providing a Web service compositing apparatus positioned in a user terminal.

Another object of the present invention is to provide a method for predicting the occurrence of a failure by unit Web service and adaptively coping with the failure.

Another object of the present invention is to provide a method for quickly and stably configuring a composite Web service.

To achieve the above objects, there is provided a method for processing Web service information, including: collecting Web service information regarding a Web service; storing the collected Web service information by Web service; learning a failure prediction based on the Web service information stored by Web service; and configuring Web service failure information regarding a failure of each Web service based on the learning of the failure prediction.

As for the Web service information, Web service information regarding a composite Web service may be collected and classified into each Web service constituting the composite Web service so as to be stored.

The Web service information may be collected by Web service.

To achieve the above objects, there is also provided a method for compositing Web services, including: executing a plurality of Web services constituting a composite Web service; obtaining Web service failure information for predicting whether each of the plurality of Web services will have an error; predicting whether each of the plurality of Web services will have an error based on the Web service failure information; when there is a substitute Web service for a failure Web service determined to have a failure according to the prediction, executing the substitute Web service instead of the failure Web service; and when there is no substitute Web service for the failure Web service, selecting a substitute device capable of executing the failure Web service, executing the failure Web service by the substitute device, and returning the execution results.

To achieve the above objects, there is also provided a Web service compositing apparatus including: a controller configured to combine a plurality of Web services to constitute a composite Web service; a communication unit configured to receive Web service failure information for predicting whether each of the Web services constituting the composite Web service will have an error, from an information storage device when the composite Web service is constituted by combining the plurality of Web services; and a storage unit configured to store the Web service failure information.

The controller may include: a failure prediction unit configured to predict whether each of the Web services constituting the composite Web service will have an error when the composite Web service is constituted, based on the Web service failure information; and a failure handling unit configured to take adaptive action against a failure Web service predicted to have a failure, among the Web services constituting the composite Web service, when the failure prediction unit determines that the failure Web service will have an error, wherein when a substitute Web service exists for the failure Web service, the adaptive action is constituting the composite Web service by executing the substitute Web service, and when a substitute Web service does not exist for the failure Web service, the adaptive action is executing the failure Web service at an outer side of the user terminal, receiving the results values of the execution, and constituting the composite Web service.

To achieve the above objects, there is provided a Web service compositing system including: first and second Web service information processing apparatuses for processing Web service information, wherein the first Web service information processing apparatus includes: a first communication unit configured to transmit and receive information via a network; a first controller configured to collect Web service information regarding a Web service via the first communication unit and generate Web service failure information by Web service based on the Web service information; and a first storage unit configured to store the Web service information and the Web service failure information by Web service, and the second Web service information processing apparatus includes: a second controller configured to combine a plurality of Web services to constitute a composite Web service; a second communication unit configured to receive Web service failure information for predicting whether each of the Web services will have an error, from the first Web service information processing apparatus when the composite Web service is constituted by combining the plurality of Web services; and a second storage unit configured to store the Web service failure information.

According to exemplary embodiments of the present invention, when a composite Web service is configured based on open APIs, a personalized composite Web service can be used by positioning a Web service compositing apparatus for combining Web services in a user terminal.

According to exemplary embodiments of the present invention, when Web services are combined, the occurrence of a failure is predicted for each unit Web service and a failure as occurs can be adaptively handled.

According to exemplary embodiments of the present invention, a composite Web service can be quickly and stably provided.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a conceptual view schematically illustrating a composite Web service according to an exemplary embodiment of the present invention.

FIG. 2 is a schematic view illustrating a Web service compositing system in a network system according to an exemplary embodiment of the present invention.

FIG. 3 is a flow chart illustrating the process of processing Web service information by a Web service information storage device according to an exemplary embodiment of the present invention.

FIG. 4 is a flow chart illustrating the process of a method for generating Web service failure information in order to predict a failure of a unit Web service in a Web service compositing system, by the Web service information storage device according to an exemplary embodiment of the present invention.

FIG. 5 is a flow chart illustrating the process of combining Web services to configure a desired composite Web service by the Web service compositing apparatus according to an exemplary embodiment of the present invention.

FIG. 6 is a schematic view illustrating a substitute Web service list stored in the Web service compositing apparatus.

FIG. 7 is a schematic view illustrating a substitute device list stored in the Web service compositing apparatus.

FIG. 8 is a schematic block diagram of a Web service information storage device according to an exemplary embodiment of the present invention.

FIG. 9 is a schematic block diagram of a Web service compositing apparatus according to an exemplary embodiment of the present invention.

### DETAILED DESCRIPTION OF THE INVENTION

The present invention proposes a user-oriented Web service compositing method in consideration of a service failure factor (e.g., a delaying factor, etc.) or the like in actually combining Web services. The phenomenon such as a service failure and a service delay problematic in dynamically combining (or compositing) Web services can be overcome effectively in consideration of a failure factor affecting the combining of the Web services, to thus provide a stable composite Web service.

According to an exemplary embodiment of the present invention, in order to realize the combination of Web services according to a dynamically changing user demand, a service failure is predicted and a service adaptation, e.g., a substitute service or a speculative execution, is performed to thus stably combine Web services. An apparatus for combining Web services, e.g., a Web service compositing scheduler, can predict failures according to the performance of a user terminal, a network state, the performance and a load state of a server, and the like through periodical and nonperiodical learning of failure factors such as a delay factor, or the like. Accordingly, the user can effectively cope with or handle a Web service failure, e.g., an execution failure or a service delay.

Exemplary embodiments of the present invention will now be described in detail with reference to the accompanying drawings. In applying reference numerals to elements of each drawing, the same reference numerals are used for the same elements although they are shown on different drawings. In describing the present invention, if a detailed explanation for a related known function or construction is considered to unnecessarily divert the gist of the present invention, such explanation has been omitted but would be understood by those skilled in the art.

It will be understood that, although the terms first, second, A, B, (a), or (b) may be used herein to describe various elements, these elements should not be limited by these terms. These terms are only used to distinguish one element from another, without limiting the essence, order, or sequence of corresponding elements. It will also be understood that when an element is referred to as being “connected with” or “coupled to” another element, it can be directly connected with the other element or intervening elements may also be present. In contrast, when an element is referred to as being “directly connected with” or “directly coupled to” another element, there are no intervening elements present.

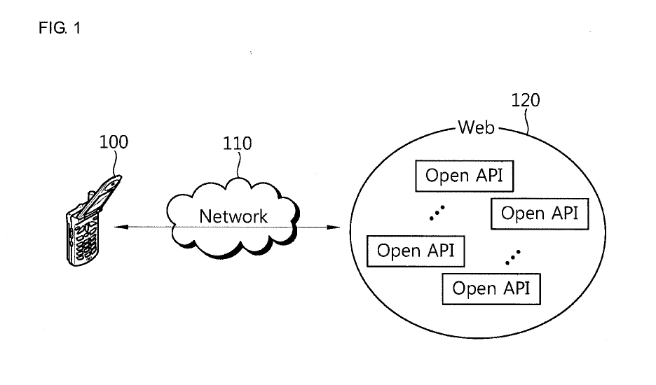

FIG. 1 is a conceptual view schematically illustrating a composite Web service according to an exemplary embodiment of the present invention. A user terminal 100 is connected to a Web 120 through a network 110. The user may combine desired Web services through the open application programming interfaces (APIs) on the Web 120 to implement a composite Web service. The open API refers to an aggregate of Web techniques allowing Web sites to interact to combine and use Web-based applications by using Java script or any other Web techniques. When a composite Web service is implemented by using the open APIs, the user does not need to develop every Web service and can implement a desired Web service by combining already existing individual unit Web services. For example a Web service can be implemented by connecting the Google map service to Google Inc., a book information service of Amazon.com, Inc., and the like. The open APIs are not applied to all the services of every Web site, and only when a platform company makes public open APIs allowing for the use of its Web services, a composite Web service can be implemented by using the corresponding Web services, and recently, open APIs are increasing.

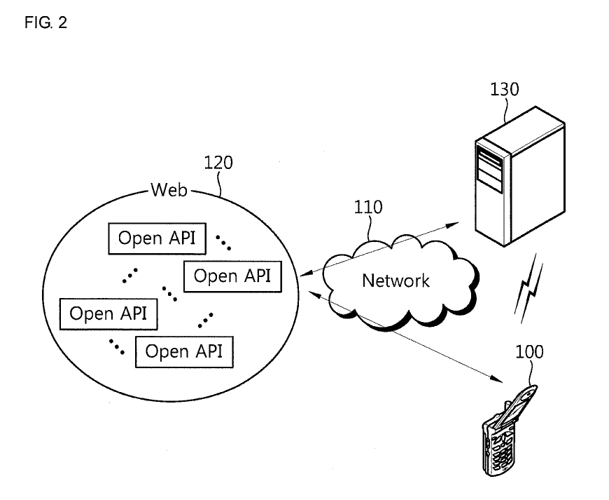

FIG. 2 is a schematic view illustrating a Web service compositing system in a network system according to an exemplary embodiment of the present invention.

The user terminal 100 may be connected to the Web 120 through the network 110 to use a Web service. Also, the user terminal 100 may be connected to the Web 120 through a Web server 130 to use a Web service.

The Web server 130 may be connected to the Web 120 through the network 110. The web server 130 includes a storage device (not shown) for collecting and storing web service information, e.g., QoS (Quality of service) information, regarding a Web service.

The Web service information storage device may collect information regarding a web service periodically or non-periodically. The Web service information storage device is able to learn a failure (i.e., a fault or an error) pattern by patterning characteristic elements (or features) of the corresponding Web service and corresponding failure factors based on the collected Web service information, e.g., the QoS information regarding the Web service. The Web service information storage device is able to generate information regarding Web service failure information, e.g., a Web service delay pattern, based on the learned content.

The user terminal 100 may be connected to the Web service information storage device to obtain the Web service failure information, and when implementing a composite Web service based on the obtained Web service failure information, the user terminal 100 can predict whether or not each of Web services constituting the composite Web service will have an error, e.g., whether or not each of the Web services will be delayed.

Thus, when constituting the composite Web service, the user terminal 100 can predict whether or not each of the Web services will have an error, and cope with it.

With reference to FIG. 2, the Web service information storage device is positioned in the Web server 130, but the present invention is not meant to be limited thereto and the Web service information storage device may be positioned anywhere so long as it can be connected to the Web 120 therefrom to obtain Web service information and provide the Web service information to the user terminal 100.

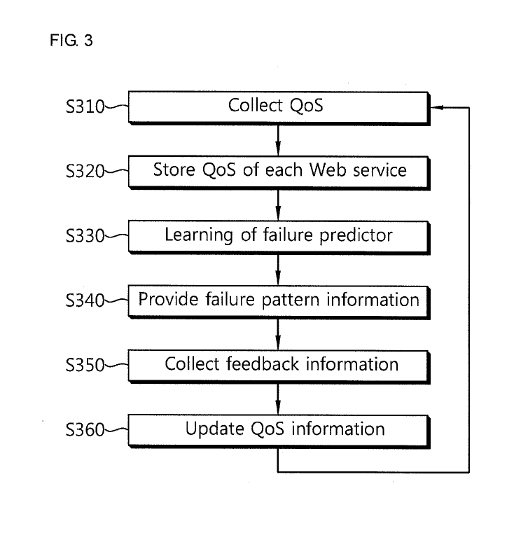

FIG. 3 is a flow chart illustrating the process of processing Web service information by a Web service information storage device according to an exemplary embodiment of the present invention.

In the following description, QoS information will be taken as an example of Web service information and a QoS storage device will be taken as an example of the Web service information storage device.

The QoS storage device collects QoS information of Web services (S310). The QoS storage device is able to collect QoS information of Web services periodically. Also, when a particular event occurs, e.g., when the user terminal 100 requests a particular Web service, the QoS storage device may collect the QoS information of the corresponding Web service. In this case, the user terminal 100 may use the Web service through the QoS storage device.

The QoS storage device stores the collected QoS information by Web service (S320). The QoS storage device may collect and store the QoS information by Web service from the beginning. Also, in case of a composite Web service, the QoS storage device may collect QoS information regarding the composite Web service and classify the QoS information by the individual Web services constituting the composite Web service and store the same. Here, the storing of the QoS information by Web service means that QoS information is stored by unit Web service constituting the composite Web service.

The QoS storage device may perform learning to predict Web service failure based on the stored QoS information of each of the Web services (S330). The QoS storage device generates Web service failure information, e.g., failure pattern information, through failure pattern leaning after determining where or not each of the Web services has an error according to the features of QoS information of each of the Web services and patterning the failures (to be described).

The QoS storage device provides the generated Web service failure information, e.g., the failure pattern information (S340). The QoS storage device may transmit failure pattern information to a target which has requested the corresponding information, or may transmit the failure pattern information to a certain target periodically according to predetermined requirements. Also, whenever a certain event occurs, e.g., whenever a Web service as a QoS collection target is added, the QoS storage device may transmit the failure pattern information to the certain target.

In this case, the certain target may be the user terminal which desires to implement a composite Web service by using Web services whose QoS information has been collected. Upon receiving the failure pattern information, the user terminal, specifically, a Web service compositing apparatus (to be described), can predict whether the corresponding Web service will have an error, e.g., whether an execution of the corresponding Web service will fail, will be delayed, or the like, based on the failure pattern information.

The QoS storage device receives feedback information from the user terminal 100 which has performed prediction on the Web service failure by using the failure pattern information (S350). The feedback information received from the user terminal 100 may be specified to the user terminal and/or a use environment of the corresponding user.

The QoS storage device updates the QoS information by using the feedback information which has been received from the user terminal 100 (S360). The feedback information received from the user terminal 100 may be specified to the corresponding user as described above. The QoS storage device may store the QoS information, which has been stored by Web service, by user by using the feedback information.

Through the foregoing method, the QoS storage device applied to the present exemplary embodiment can provide information reflecting a dynamically changing QoS state to the system.

Here, the present exemplary embodiment has been described by using the QoS information and the QoS storage device, but the present invention is not meant to be limited to the case of using the QoS information and the QoS storage device and can be implemented by using a Web service or different information on the Web within the scope of the technical concept of the present invention.

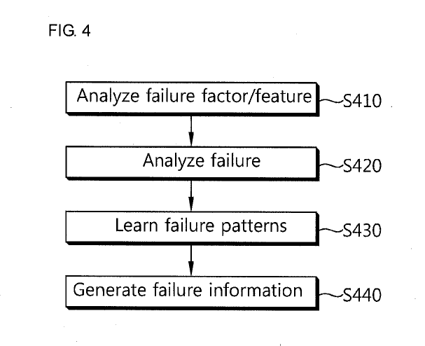

FIG. 4 is a flow chart illustrating the process of a method for generating a Web service failure in order to predict a failure (e.g., a service delay, a service fault, etc.) of a unit Web service in a Web service compositing system, by the Web service information storage device according to an exemplary embodiment of the present invention.

Hereinafter, QoS information will be taken as an example of Web service information, and a QoS storage device will be taken as an example of a Web service information storage device in describing a generation of Web service failure information by the Web service information storage device.

The QoS storage device classifies the failure determination elements and features from collected QoS information and check them (S410). The failure determination elements obtained from the QoS information may include Web service availability, a response time, an open API format/type, the location of a server, the category of Web services, an average response time, and the like, by unit Web service constituting the composite Web service. Here, the Web service availability, the response time, the open API format/type, the location of a server, the category of Web services, the average response time were enumerated as the failure determination elements, but the present invention is not meant to be limited thereto and any characteristic elements (features) which can be used as a basis for determining a failure can be used as a failure determination element.

The QoS storage device analyzes a failure by the failure determination element with respect to a unit Web service (S420). For example, the QoS storage device analyzes the basis for determining a failure, such as a failure occurrence probability according to the Web service availability, a response standby time considered to be a generated failure, a failure occurrence probability of each of the open API formats/types, a failure occurrence rate according to the distance to the server, and the like.

When is to be considered as a time for determining a failure occurrence may be set by a system manager according to each failure determination element or each situation. For example, the system manager may set a time when a response standby time of 20 ms or longer has lapsed after executing a service, as a failure occurrence.

Also, an initial setting of a failure determination may be performed by the manager, and whether a failure has occurred can be automatically determined thereafter. For example, it may be determined that, at first, when the response standby time exceeds 20 ms, it may be determined as a failure, and then after the same open APIs are performed several times, an accumulated average of the response standby time is calculated to be used as a reference of failure determination.

Here, the failures with respect to the Web service availability, the response time, the open API format/type, the location of a server, the category of a Web service, and the average response time have been described, but the present invention is not meant to be limited thereto an any types of failures which can be used as a basis for predicting a failure occurrence may be used for a failure analysis.

The QoS storage device performs learning failure patterns (S430). Namely, the QoS storage device patterns the generated failures of each failure determination element to learn them. An actual model for learning Web service failure patterns may include a maximum entropy model, a support vector machine model, and the like. Also, when a sequential delay is discovered, a conditional random field model may be used. A plurality of learning models may be combined to be used as necessary.

The QoS storage device generates Web service failure information, e.g., failure pattern information, through the failure learning (S440). The QoS storage device transmits the generated Web service failure information to the Web service compositing apparatus. In this case, the Web service failure information may be transmitted upon receiving a corresponding request from the Web service compositing apparatus, periodically, or when a particular event, e.g., when new Web service failure information is generated. The Web service compositing apparatus may predict whether the unit Web services will have an error based on the Web service failure information, e.g., the failure pattern information.

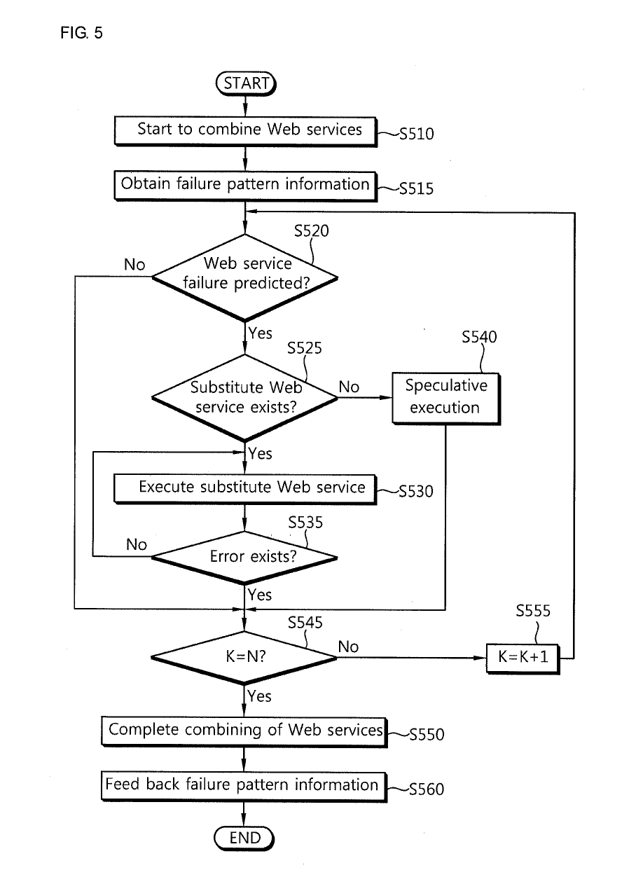

FIG. 5 is a flow chart illustrating the process of combining Web services to configure a desired composite Web service by the Web service compositing apparatus according to an exemplary embodiment of the present invention.

The Web service compositing apparatus according to an exemplary embodiment of the present invention may be, for example, a QoS-based user-oriented Web service compositing scheduler. The Web service compositing apparatus schedules the individual elements generated when combining the respective Web services, e.g., the factors such as the number of composite Web services, the implementation type of an open API, the location of a server, and the like, to be considered in combining Web services, predicts a Web service failure generated when combining the Web services, and adaptively configure a composite Web service accordingly.

Here, it is described that the Web service failure information is generated by the Web service information storage device, but the present invention is not meant to be limited thereto and the user terminal may generate Web service failure information through failure leaning and store the same, so as to predict the occurrence of a failure of each of the unit Web services in configuring a composite Web service.

As discussed above, the Web service compositing apparatus according to an exemplary embodiment of the present invention is positioned in the user terminal 100 and may predict a service failure such as delay of an individual Web service in configuring a composite Web service, based on the Web service failure information which is generated by the Web service compositing apparatus through failure learning by itself or based on Web service failure information such as failure pattern information generated by the Web service information storage device, e.g., the QoS storage device.

When the user inputs information regarding his desired composite Web service, the Web service compositing apparatus calls the respective unit Web services (WS_K) constituting the desired composite Web service and starts to combine them (S510). The user may arbitrarily combine various unit Web services as necessary. For example, the user may combine an API providing information regarding the weather and an API providing geographical information in order to implement ‘weather information according to location’ as a Web service.

The combining of the several Web services (or APIs) has a high possibility in which delay or other failures will occur compared with calling only one Web service. For example, failures of the Web services may be generated by various factors. These factors can be divided into server-side factors and client-side factors as shown in Table 1 below.

TABLE 1

| | Factor | Description |
|---|---|---|
| Server side | Location of each server | Delay due to physical |
| | | distance to server |
| | Open API implementation | Delay differentiated by |
| | type | encapsulation scheme and |
| | | decapsulation scheme |
| | | according to open API |
| | | implementation types |
| Client side | Location of user | Delay caused by physical |
| | | distance to user |
| | Communication medium | Network delay caused by |
| | | type of wired/wireless/3G |
| | | network |
| | Performance of user device | Delay caused by |
| | | performance of central |
| | | processing calculation |
| | | device and the capacity of |
| | | RAM of user device |
| | The number of combined | Delay caused as a plurality |
| | open APIs | of different open APIs are |
| | | combined |

The results obtained by combining the unit Web services a plurality of times for each combination of corresponding values of the respective factors described in Table 1 with respect to a composite Web service obtained by combining the plurality of unit Web services, while changing the values of the respective factors, show that delay has occurred by 30% in performing the Web services. The factors greatly affecting the Web service performing time were the number of unit Web services, the open API implementation type, and the location of a server in this order.

When the user or a service provider, or particularly, the user's Web service compositing apparatus according to an exemplary embodiment of the present invention is able to predict a failure such as delay generated when combining the unit Web services and adaptively cope with it, a fast composite Web service can be implemented. The influence of the foregoing failure factors can be hardly regulated at a network level relaying the Web services and can be overcome through flexible scheduling by the Web service compositing apparatus according to an exemplary embodiment of the present invention.

The Web service compositing apparatus may obtain Web service failure information, e.g., failure pattern information, required for predicting a failure of each of the unit Web services (S515). The Web service compositing apparatus may request the failure pattern information from the Web service information storage device, e.g., the QoS storage device, to obtain the failure pattern information required for predicting a failure. Or, the Web service compositing apparatus may obtain the Web service failure information, e.g., the failure pattern information, at every time determined according to a certain agreement from the Web service information storage device. Or, the Web service compositing apparatus may obtain the Web service failure information, e.g., the failure pattern information, when a certain event occurs, e.g., when a unit Web service supporting an open API which can constitute a composite Web service is added. Or, the Web service compositing apparatus may obtain QoS information from the Web service information storage device, learn failure patterns, and generate Web service failure information. In this case, the Web service compositing apparatus may store the Web service failure information generated by the Web service compositing apparatus itself in a memory or a storage unit, and use the same, instead of the Web service failure information generated by the Web service storage device, in order to predict a failure of each of the unit Web services.

The Web service compositing apparatus predicts whether the unit Web services (WS_K) constituting the composite Web service will have an error, based on the obtained Web service failure information, e.g., the failure pattern information (S520). For example, the Web service compositing apparatus predicts whether or not the unit Web services (WS_K) constituting the composite Web service will be delayed through a time taken up to now after they are called along with the foregoing QoS elements such as the name of Web servers, the open API types, the locations of servers, and the like, based on the failure pattern information obtained from the Web service information storage device.

For example, the Web service compositing apparatus may determine that performing of a unit Web service will be delayed, based on a maximum processing time on the basis of an average performing time of each of the unit Web services constituting the user desired composite Web service. The average performing time, the maximum processing time, and the like, of each of the unit Web services can be obtained through the Web service failure information generated by the Web service information storage device.

When the Web service compositing apparatus uses a binary classifier to predict a failure, e.g., delay, the prediction results can be divided into delay or okay (i.e., normal execution).

Here, it is described that the Web service compositing apparatus predicts the occurrence of a failure of each of the unit Web services by using the Web service failure information generated by the Web service storage device, but the present invention is not meant to be limited thereto and the Web service compositing apparatus may predict the occurrence of a failure of each of the unit Web services by using the Web service failure information generated by the Web service compositing apparatus itself as described above.

As afore-mentioned, the user desired composite Web service is composed of the plurality of unit Web services. When a first selected unit Web service is predicted to have an error, the Web service compositing apparatus according to an exemplary embodiment of the present invention performs adaptation on the first selected unit Web service, rather than executing the first selected unit Web service. The adaptation includes an execution of a substitute Web service and a speculative execution (to be described).

When a Web service is predicted to have an error, the Web service compositing apparatus determines whether or not there is a substitute Web service for the corresponding Web service (S525). The substitute Web service is a Web service which can obtain the same results as those of the unit Web service first selected by the user.

When there is a substitute Web service for the Web service predicted to have an error, the Web service compositing apparatus obtains the substitute Web service and executes it (S530).

FIG. 6 is a schematic view illustrating a substitute Web service list stored in the Web service compositing apparatus.

The Web service compositing apparatus may have a substitute Web service list for each of the unit Web services in the memory or the storage unit. Also, the Web service information storage device may generate a substitute Web service list for each of particular Web services in the process of collecting Web service information, e.g., QoS information, include the same in the Web service failure information, and transmit the same to the Web service compositing apparatus.

The Web service compositing apparatus may select a substitute Web service for a failure-predicted unit Web service from the substitute Web service list. The Web service compositing apparatus may select a substitute Web service positioned at the forefront on the substitute Web service list, or may randomly select a substitute Web service from the substitute Web service list. Also, when the Web service information storage device generates a substitute Web service list, the substitute Web service list may be configured in order starting from the most appropriate substitute Web service to replace a failure-generated unit Web service based on Web service information, e.g., QoS information, or the like, of the corresponding Web service. In this case, the Web service compositing apparatus may select the substitute Web service in order from the substitute Web service list.

The Web service compositing apparatus predicts whether or not the executed substitute Web service will have an error (S535). The Web service compositing apparatus may predict whether or not the substitute Web service will have an error based on a time taken after the Web service is called, or the like, along with the values of QoS elements such as the location and name of a Web server with respect to the selected substitute Web service, the open API type, or the like, based on the failure pattern information obtained from the Web service information storage device. Also, in a state in which there is no service failure information obtained from the Web service storage device with respect to the selected substitute Web service, when a time that has passed without executing the substitute Web service upon being called lapses a certain reference time, the Web service compositing apparatus may predict that the substitute Web service will have an error.

When the selected substitute Web service is predicted to have an error, the Web service compositing apparatus may select a substitute Web service again (S530).

The Web service compositing apparatus may select a next substitute Web service from the substitute Web service list or may randomly select a different substitute Web service. Also, when the Web service information storage device makes the substitute Web service list and configures the list in order appropriate for replacing a first Web service, the Web service compositing apparatus may select a substitute Web service positioned next to the substitute Web service predicted to have an error.

Here, it is described that the error of the substitute Web service is predicted and coped with, but, unlike the first unit Web service randomly selected by the user, when the substitute Web service list is made based on the Web service information such as the QoS information, or the like, the substitute Web service selected by the Web service compositing apparatus from the substitute service list generally does not have a problem with execution. Namely, when the substitute Web service list is generated based on the Web service information such as the QoS information, or the like, by the Web service storage device, or the like, substitute Web services satisfying data semantics (an input/output of Web services) and functional semantics (Web service performing function) can be prepared and aligned in order expected to perform the fast and stable execution. Thus, the step (S535) of determining a failure of the substitute Web service may not be executed according to an embodiment environment or situation of the invention.

When there is no substitute Web service, the Web service compositing apparatus performs a speculative execution (S540). The speculative execution is performed in case in which, when it is predicted that a Web service will have an error, the unit Web service predicted to have an error is performed by a different node, i.e., a different machine, in the network and the result value is received and used to configure a composite Web service.

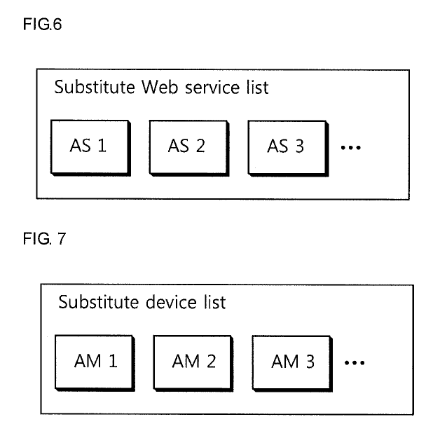

FIG. 7 is a schematic view illustrating a substitute device list stored in the Web service compositing apparatus.

The Web service compositing apparatus may have a substitute device list for each of unit Web services in the memory or the storage unit. Also, the Web service information storage device may generate a substitute device list for each of particular Web services in the process of collecting Web service information, e.g., QoS information, include the same in the Web service failure information, and transmit the same to the Web service compositing apparatus.

The Web service compositing apparatus may select a substitute device for a failure-predicted unit Web service in the place of the Web service compositing apparatus or the user terminal in which the Web service compositing apparatus is installed from the substitute device list. The Web service compositing apparatus may select a substitute device positioned at the forefront on the substitute device list, or may randomly select a substitute device from the substitute Web service list. Also, when the Web service information storage device generates a substitute device list, the substitute device list may be configured in order starting from the most appropriate substitute device to perform a failure-generated unit Web service based on Web service information, e.g., QoS information, or the like, of the corresponding Web service. In this case, the Web service compositing apparatus may select the substitute device in order from the substitute Web service list.

Here, it is described that the Web service compositing apparatus selects the substitute device for executing the failure-predicted Web service from the substitute device list, but in performing the speculative execution according to an exemplary embodiment of the present invention, when a composite Web service is configured, a unit Web service may be executed in a different node, rather than in the current Web service compositing apparatus having an error in executing the corresponding unit Web service, and the result value may be returned. For example, a certain substitute device may be previously determined for each Web service compositing apparatus and only a result value may be received from a server providing a corresponding unit Web service. In addition, when the Web service compositing apparatus mounted in the user terminal and the user terminal can execute a Web service, respectively, namely, when the Web service compositing apparatus mounted in the user terminal operates separately from the user terminal and outputs only a configured composite Web service to the user terminal, a part other than the Web service compositing apparatus in the user terminal may be used as a substitute device.

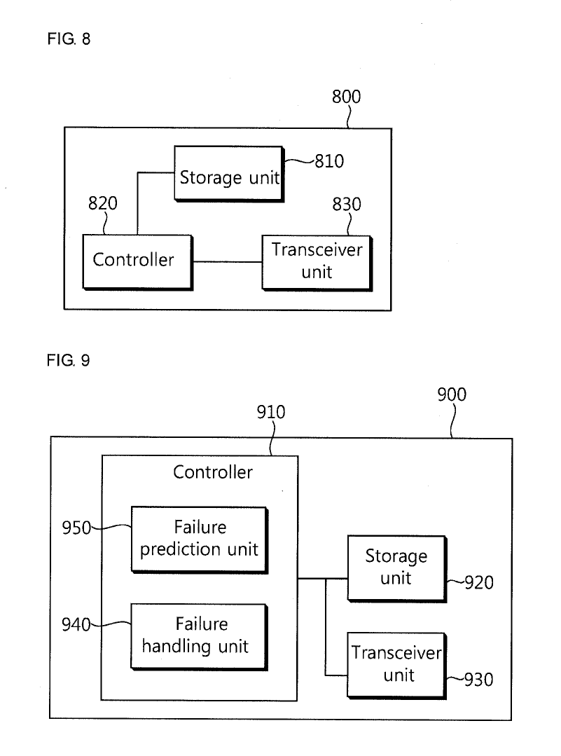

FIG. 8 is a schematic block diagram of a Web service information storage device according to an exemplary embodiment of the present invention.

A Web service information storage device 800 includes a storage unit 810, a controller 820, and a transceiver unit 830.

The transceiver unit 830 is connected to a Web through a wired/wireless network. The transceiver unit 930 collects Web service information, e.g., QoS information, with respect to each of Web services on the Web. The transceiver unit 830 transmits information generated by the Web service information storage device 800 to objects which need it and receives corresponding feedback information.

The storage unit 810 stores information received by the transceiver unit 930 and information classified or generated by the controller 820.

The controller 820 classifies the collected Web service information, e.g., the QoS information, by unit Web service and store the same in the storage unit 810. Also, the controller 820 generates Web service failure information through required failure determination learning based on the collected/stored Web service information, e.g., the QoS information.

FIG. 9 is a schematic block diagram of a Web service compositing apparatus according to an exemplary embodiment of the present invention.

A Web service compositing apparatus 900 is positioned in a user terminal. The Web service compositing apparatus 900 schedules operations required for configuring a composite Web service.

The Web service compositing apparatus 900 includes a controller 910, a storage unit 920, and a transceiver unit 930, and the controller 910 includes a failure prediction unit 950 and a failure handling unit 940.

The transceiver unit 930 is connected to a Web through a network and transmits and receives information required for configuring a composite Web service.

The controller 910 configures a composite Web service with unit Web services. The controller 910 may generate Web service failure information based on Web service information obtained from a Web service information storage device.

The failure prediction unit 920 predicts a failure of each of unit Web services based on the Web service failure information generated by the Web service information storage device or the Web service compositing apparatus.

The failure handling unit 930 takes an adaptive action against a failure-predicted unit Web service. The adaptive action taken by the failure handling unit 930 includes selecting a substitute Web service and executing the selected substitute Web service, and selecting a substitute device and executing a failure-predicted Web service by using the selected substitute device to obtain a result value. The controller 900 can configure a composite Web service by using the results of the adaptive action, thus configuring the composite Web service quickly and stably.

In the foregoing exemplary system, the methods are described based on the flow chart as sequential steps or blocks, but the present invention is not limited to the order of the steps and some of them may be performed in order different from the order of the foregoing steps or simultaneously. Also, a skilled person in the art will understand that the steps are not exclusive but may include other steps, or one or more steps of the flow chart may be deleted without affecting the scope of the present invention.

As the present invention may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. A method for processing Web service information, the method comprising:
collecting Web service information regarding a Web service;
storing the collected Web service information by Web service;
learning a failure prediction based on the Web service information stored by Web service; and
configuring Web service failure information regarding a failure of each Web service based on the learning of the failure prediction.

2. The method of claim 1, wherein the Web service information is collected periodically.

3. The method of claim 1, wherein the Web service information is collected whenever there is a request for the Web service in a network.

4. The method of claim 1, wherein the Web service information regarding a composite Web service is collected, and the composite Web service is classified into Web services constituting the composite Web service.

5. The method of claim 1, wherein the Web service information is collected by Web service.

6. The method of claim 1, wherein the Web service information comprises at least one of information regarding whether or not each Web service supports an open application programming interface (API), an open API format/type, the location of a server with respect to each Web service, the category of Web services, the availability of each Web service, a response time with respect to a service request, and an average response time with respect to a service request.

7. The method of claim 1, further comprising:
transmitting the Web service failure information according to a request.

8. The method of claim 7, further comprising:
receiving feedback information corresponding to the transmitted Web service failure information and updating the Web service failure information for each object which has transmitted the feedback information.

9. A method for compositing Web services, the method comprising:
executing a plurality of Web services constituting a composite Web service;
obtaining Web service failure information for predicting whether each of the plurality of Web services will have an error;
predicting whether each of the plurality of Web services will have an error based on the Web service failure information;
when there is a substitute Web service for a failure Web service determined to have a failure according to the prediction, executing the substitute Web service instead of the failure Web service; and
when there is no substitute Web service for the failure Web service, selecting a substitute device capable of executing the failure Web service, executing the failure Web service by the substitute device, and returning the execution results.

10. A Web service compositing apparatus comprising:
a controller configured to combine a plurality of Web services to constitute a composite Web service;
a communication unit configured to receive Web service failure information for predicting whether each of the Web services constituting the composite Web service will have an error, from an information storage device when the composite Web service is constituted by combining the plurality of Web services; and
a storage unit configured to store the Web service failure information.

11. The apparatus of claim 10, wherein the information storage device is located outside the user terminal.

12. The apparatus of claim 10, wherein the controller comprises:
a failure prediction unit configured to predict whether each of the Web services constituting the composite Web service will have an error when the composite Web service is constituted, based on the Web service failure information; and
a failure handling unit configured to take adaptive action against a failure Web service predicted to have a failure, among the Web services constituting the composite Web service, when the failure prediction unit determines that the failure Web service will have an error,
wherein when a substitute Web service exists for the failure Web service, the adaptive action is constituting the composite Web service by executing the substitute Web service, and when a substitute Web service does not exist for the failure Web service, the adaptive action is executing the failure Web service at an outer side of the user terminal, receiving the results values of the execution, and constituting the composite Web service.

13. The apparatus of claim 10, further comprising:
a storage unit configured to store a substitute Web service list,
wherein the failure handling unit obtains the substitute Web service with respect to the failure Web service from the substitute Web service list.

14. The apparatus of claim 12, further comprising:
a storage unit configured to store a substitute machine list,
wherein the failure handling unit selects a substitute machine for executing the failure Web service from the substitute machine list and returns the execution results of the failure Web service performed by the substitute machine.

15. A Web service compositing system comprising:
first and second Web service information processing apparatuses for processing Web service information,
wherein the first Web service information processing apparatus comprises:
a first communication unit configured to transmit and receive information via a network;
a first controller configured to collect Web service information regarding a Web service via the first communication unit and generate Web service failure information by Web service based on the Web service information; and
a first storage unit configured to store the Web service information and the Web service failure information by Web service, and
the second Web service information processing apparatus comprises:
a second controller configured to combine a plurality of Web services to constitute a composite Web service;
a second communication unit configured to receive Web service failure information for predicting whether each of the Web services will have an error, from the first Web service information processing apparatus when the composite Web service is constituted by combining the plurality of Web services; and
a second storage unit configured to store the Web service failure information.

16. The system of claim 15, wherein the second Web service information processing apparatus is located in a user terminal and outputs the composite Web service from the user terminal.

17. The system of claim 15, wherein the second controller comprises:
a failure prediction unit configured to predict whether each of the Web services constituting the composite Web service will have an error when the composite Web service is constituted, based on the Web service failure information; and
a failure handling unit configured to take adaptive action against a failure Web service predicted to have a failure, among the Web services constituting the composite Web service, when the failure prediction unit determines that the failure Web service will have an error,
wherein when a substitute Web service exists for the failure Web service, the adaptive action is constituting the composite Web service by executing the substitute Web service, and when a substitute Web service does not exist for the failure Web service, the adaptive action is executing the failure Web service at an outer side of the user terminal, receiving the results values of the execution, and constituting the composite Web service.
